(19) United States
(12) Patent Application Publication
(10) Pub. No.: US 2012/0052471 A1
(43) Pub. Date: Mar. 1, 2012

(54) INTERACTIVE ATOMIC MODEL

(75) Inventors: Anna Kristensson, Ljungsbro (SE); Pernilla Molander, Norrkoping (SE)

(73) Assignee: BRIGHT AB, Linkoping (SE)

(21) Appl. No.: 11/814,725

(22) PCT Filed: Dec. 1, 2005
(86) PCT No.: PCT/SE2005/001830

§ 371 Date: Mar. 21, 2008

(30) Foreign Application Priority Data
Jan. 26, 2005 (SE) 0500192-0

(51) Int. Cl. G09B 23/26

(52) U.S. Cl. 434/280

(57) ABSTRACT

The present invention provides an interactive atomic model that comprises a compartment (201) that is enclosed by walls and a lid (100) that can be opened, and at least two elementary particle models (301, 302, 303) which are contained in the compartment (201). The lid (100) has an atomic model surface (101) that defines a centre area (103) and a number of closed orbits (102), whereby said centre area (103) defines resting positions that are well defined in space for at least one of said elementary particle models (301, 302, 303) and said closed orbits (102) defines resting positions that are well defined along the respective closed orbit or at least one of said elementary particle models (301, 302, 303). The interactive atomic model thereby enables simple and effective understanding for the constitution of atoms.

### TECHNOLOGICAL AREA

The present invention relates to an interactive atomic model suitable for illustrating various combinations of elementary particles making up atoms or ions.

### TECHNOLOGICAL BACKGROUND

For many people, it can be difficult to really understand the way atoms look, how the number of their elementary particles varies, and how they transform to ions. The composition of atoms and ions is presently illustrated by two-dimensional drawings and descriptions. However, this kind of education can actually be impossible to benefit from for persons having some kind of dysfunction, not the least for persons having impaired vision or hearing. It is difficult to understand the big picture within chemical education without first having a proper understanding for the composition of atoms. Hence, there is a great need for improved means of education regarding the composition of atoms.

One way for people to really understand the operation of atoms is to work with the different parts by hand. Laboratory material allows the user to employ more senses in the learning process and thereby simplifies understanding of the composition of atoms and ions. Laboratory material is available for illustration of the creation and composition of molecules, where atoms are represented by balls that are put together by means of different couplings to illustrate the composition of the molecule. However, there are no corresponding alternatives for illustrating the composition of atoms and ions.

### BRIEF DESCRIPTION OF THE INVENTION

According to the present invention, the lack of suitable educational material for illustrating the composition of atoms is relieved by an interactive atomic model that allows pupils to employ their own body during the learning process. It is thereby possible to convey a natural feel and understanding for the composition of atoms and ions.

According to the present invention, the interactive atomic model includes a compartment that is enclosed by walls and that has a lid that can be opened, and at least two elementary particle models which are contained in the compartment. The lid has an atomic model surface that defines a centre area and a number of closed tracks encircling the centre area. The centre area defines resting positions that are well defined in space for at least one of the elementary particle models, and the closed tracks define well-defined resting positions along respective track for at least one of the elementary particle models.

The present invention thus provides an interactive atomic model that provides both an integrated storing system for the accompanying parts (i.e. the elementary particle models) and a space in which the composition of the atom can be naturally and intuitively illustrated (i.e. the atomic model surface).

According to one embodiment, the elementary particle models correspond to different types of elementary particles. According to one particularly preferred embodiment the elementary particle models correspond to protons, electrons, and neutrons, which enable illustration of all types of atoms and their respective states.

According to one embodiment the different types of elementary particles are distinguishable by physically touching them. For example, this can be facilitated by equipping them with a depressed or elevated character. In case of protons, electrons, and neutrons; protons can for example be provided with an elevated plus-sign (+), electrons can be provided with an elevated minus-sign (−), and neutrons can be left without any particular sign. This allows simple distinction also for persons having impaired vision.

According to one embodiment the different types of elementary particle models are visually distinguishable, for example by providing them with different colours or colour markings. Protons can for example be provided in blue, electrons can be provided in red, and neutrons can be provided in white. Colour markings can indeed be employed in combination with physically distinguishable signs in accordance with the teaching above. By colour markings the different types of elementary particles can be made even more distinguishable.

According to one embodiment the centre area and the closed tracks are defined on the atomic model surface by elevations and depressions in said atomic model surface. The centre area and the closed tracks can, for example, be separated from each other by means of an elevated flange whereby the centre area and the closed tracks also can be seen as depressions in the atomic model surface compared to the elevated flanges.

According to one embodiment the atomic model surface and the elementary particles are made with magnets and magnetic material in such way that a magnetic force pulls the elementary particles towards the atomic model surface. According to one embodiment the centre area and the closed tracks are defined by magnetic forces such that the elementary particles are drawn by the magnetic force on the atomic model surface to a position that corresponds either to one of the closed tracks or to the centre area. This can be achieved for example by defining the closed tracks by magnetic material with a particular charge and by defining the areas that separates the tracks by magnetic material having the opposite charge. By providing the elementary particle models with magnets of opposite charge they will be drawn toward either of the closed tracks and away from the separating area.

Magnetic forces can also be used in combination with other separating means. The magnetic force may then serve mainly to stabilise the position of the elementary particle models on the atomic model surface.

### BRIEF DESCRIPTION OF THE DRAWINGS

FIG. 1 illustrates the atomic model in use; a container with a lid having elevated, equidistant, concentric slits that represent the electron shells. FIG. 1 also illustrates the positions of the elementary particles on the atomic model where the protons (marked with the character “+”), and neutrons (two-coloured) are placed in a depressed circular space in the centre of the lid. The electrons (marked with the character “−”) are placed on different electron shells.

FIG. 2 illustrates the atomic model when it is not in use and the elementary particles are stored in the container. FIG. 2 also illustrates the slits in the electrons that enable them to slide along the different electron shells.

FIG. 3 illustrates the additional set of concentric, equidistant elevations that are arranged on the bottom side of the container and on which elementary particles can be positioned for creation of yet one atom or ion.

### PREFERRED EMBODIMENTS

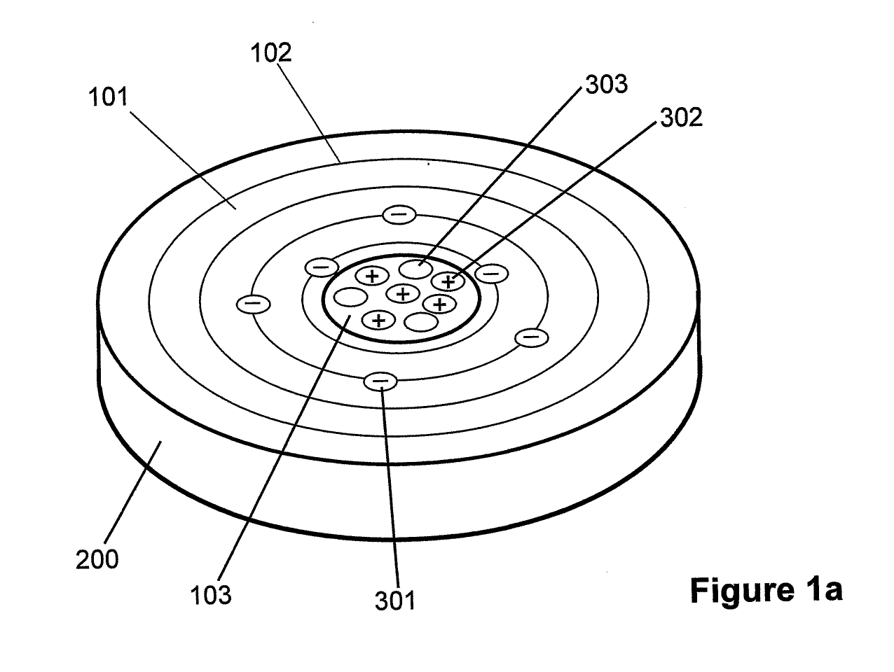

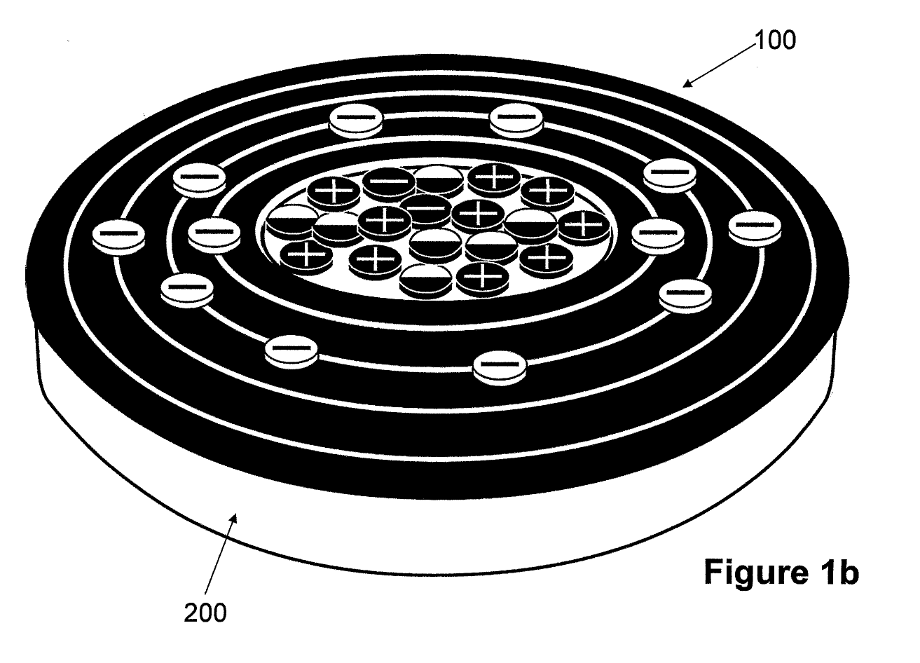

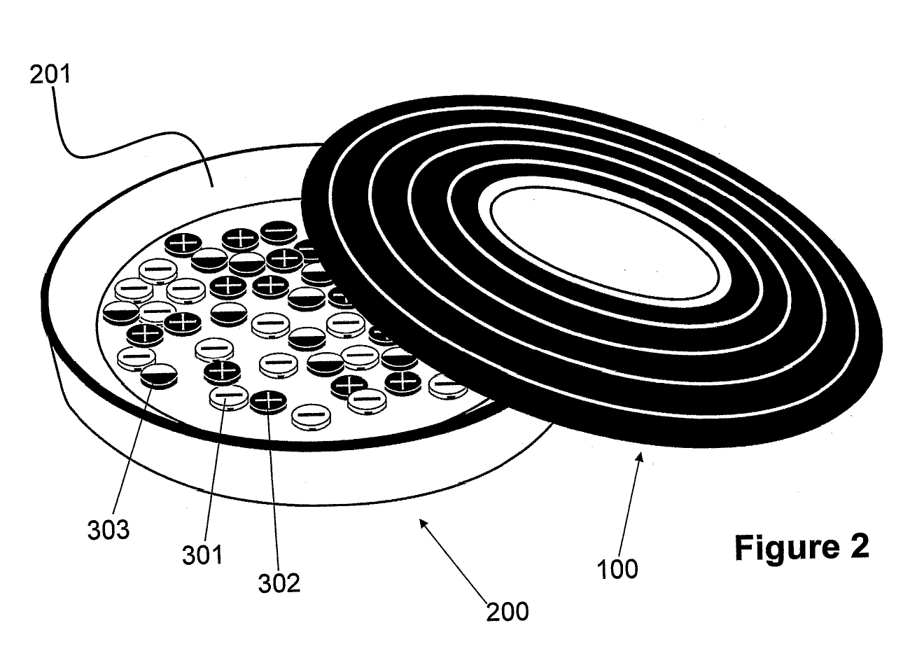

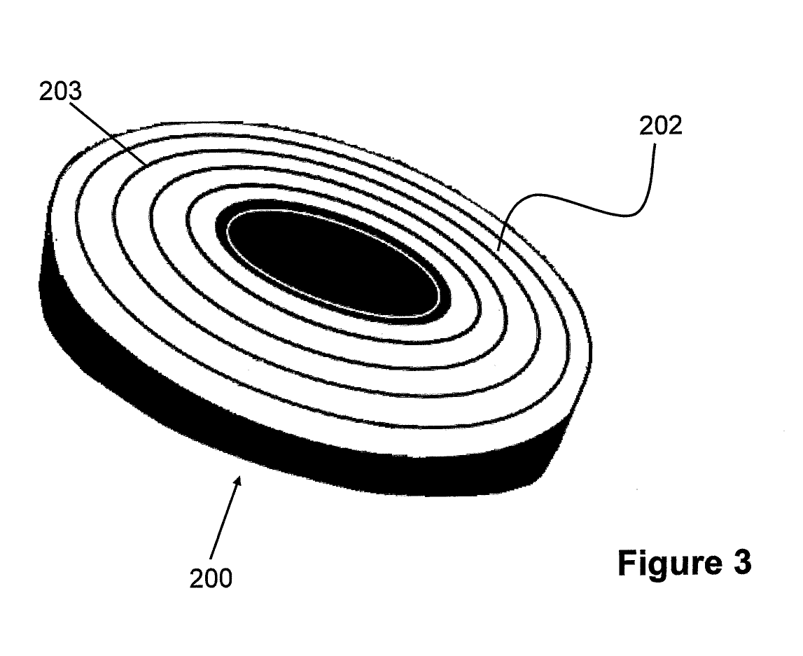

One embodiment of the invention is schematically illustrated on the attached drawings where FIGS. 1a and 1b illustrate how the elementary particles 301, 302, 303 can be positioned on the elevations 102 that represent the electron shells, and FIG. 2 illustrates the interactive atomic model when it is not in use and the elementary particles 301, 302, 303 are stored in the compartment 201 of the container 200. FIG. 3 illustrates the additional set of electron shells that are provided on the bottom side 202 of the container 200.

The invention according to FIG. 1 and FIG. 2 provides a container 200 with a lid 100, where the upper side 101 of the lid houses electron shells 102, and a depressed circular space 103 in the centre. Said depressed circular space 103 represents the atomic nucleus. The elementary particles are stored in the container 200; protons 302, electrons 301, and neutrons 303. The elementary particles are placed in said depressed circular space 103 or on the electron shells 102. On the bottom side of said container 200 there is, according to FIG. 3, yet one set of electron shells 203 in order to readily illustrate the creation of ions. The two sets of electron shells 102, 203 provide the possibility to have two atoms built simultaneously and thereby transforming said atoms to ions.

According to FIG. 1a, FIG. 1b, FIG. 2, and FIG. 3 said atomic model has four electron shells, but in alternative designs it may have a larger or a smaller number of electron shells 102, 203 in order to adapt to different user-levels.

The atomic model can be provided in a number of designs. The size can be varied in order to its purpose. For school teaching a circular model with a diameter of 20 cm might be suitable in order to be used by pupils on their desks and to be stored in storerooms. Smaller models might be useful in different situations, for example if they should be portable.

A larger model might be used in order to be able to move the elementary particles by walking around the atom. The atomic model is based on Bohrs circular atomic model, but it can also be formed in different varieties, such as elliptical, angular or in different shapes. It is also possible to change the height of the container, the lid, or the elementary particles.

The lid houses the electron shells. According to the embodiment that is illustrated in the drawings said electron shells 102, 203 are elevated slits formed such that the elementary particles can slide on them without slipping off. The bottom faces of the elementary particles are suitably provided with depressed slits that are adapted to ride along the slits of the electron shells. An alternative design of the shells is to make them magnetic such that they retain the elementary particles. Yet one alternative design is that the electron shells are not elevated in order to facilitate free movement of the elementary particles on the model. Alternatively said electron shells can be depressed, and in that design the elementary particles can be moved along the electron shells by featuring an elevated slot on the bottom face of the elementary particle that fits into the depressions of the electron shells.

The electron shells 102, 203 can be varied in height and width in order to fit different uses. Also the look of the electron shells can be varied, for example by forming said electron shell with rounded upper edges, vertical sides, or angled sides. Said depressed circular space may in alternative designs be elevated, coated with a surface structure, be magnetic, or be excluded.

The height, width and size of the container 200 can also be varied. According to the illustrated embodiment the atomic model is based on Bohrs circular atomic model. But it can alternatively be made in different forms. In an alternative embodiment said container may be equally high as said lid in order to achieve equal height when they are placed next to each other. This embodiment simplifies the demonstration of the formation of ions.

As is illustrated in FIG. 3 the container 200 can also be provided with a set of electron shells in its bottom side. These electron shells are elevated in order for the elementary particles to travel on them without slipping off. In an alternative embodiment the electron shells are not elevated. In yet one embodiment the electron shells are depressed and the positions of the elementary particles are guided by elevated slots on the bottom face of the elementary particles. It is also possible to place said electron shells on the bottom face of the interior of the container instead of being placed on the bottom side of the container. Said additional set of electron shells can advantageously have a different colouring than the set of electron shells that is placed on top of the lid. Thereby colourful contrasts are created that, for example, can be useful for users having impaired vision.

The formation of ions is normally quite difficult for pupils to understand. The purpose of having a set of electron shells on the bottom side of the container is to illustrate the formation of ions in practice by building two separate atoms; one on the electron shells of the container and one on the electron shells of the lid. The formation of ions is easily illustrated by moving of the valence electron/electrons from one atom to the other atom. The charge of ions is also illustrated clearly for the user since the transfer of valence electron/electrons is performed by the user himself.

Said elementary particles 301, 302, 303 are circular according to FIG. 1a, FIG. 1b, and FIG. 2. Two types have elevated symbols on their upper side. The protons 302 are marked with an elevated plus-sign, the electrons 301 are marked with an elevated minus-sign, and the neutrons 303 lack any corresponding marking. According to an alternative embodiment the elementary particles all lack elevations. In alternative designs said elementary particles can be varied in height, width, material, and shape. According to FIG. 2 the bottom face of the elementary particles 301, 302, 303 has a slit that is dimensionally adapted to fit on the electron shells 102, 203 such that they can slide around any selected electron shell 102, 203 without slipping off. In the above described embodiment the electrons shells 102, 203 can alternatively be depressed and the elementary particles can be provided with a elevated slit in order to fit the depressions of the electron shells. Yet one alternative is to provide said elementary particles with different surface structures on their upper side, in order to simplify identification of the different types by persons having impaired vision. Said elevations on the elementary particles may be formed from different material, for example rubber. In order to achieve a magnetic effect the elementary particles can be provided with a magnet in the slit on the bottom side while at the same time forming the electron shells in a magnetic material. The magnetic effect in the alternative embodiment provides the advantage that the elementary particles do not slip off the electron shells. Another alternative embodiment is to provide only the electrons with a slit on their bottom faces, since only the electrons are actually used on said electron shells. In said alternative embodiment where the electron shells are not elevated and the electrons can travel freely over the entire model all the elementary particles can be made without slits on their bottom faces.

In alternative embodiments the atomic models are provided with accessories. A bar designed to be put on the lid or the bottom side of the atomic model in order to stop the travel of the elementary particles along the electron shells is one example of an accessory. This accessory is advantageously used by blind persons or persons having impaired vision since the bar can be used to aid counting of the number of electrons on the electron shells. The bar can for example be put on the atomic model such that it stretches from the edge of the nucleus to the edge of the lid. According to one embodiment it can be clipped on to prohibit it from slipping around. In case the electron shells are elevated the bar can have slits on its bottom side that correspond to the shape of the atomic model. The user can use said bar as a stop in the electron orbit in order to collect all electrons in one and the same place. Thereby users having impaired vision can use the bar to easily collect all electrons that have been placed on said electron shells by means of their fingers. This solution simplifies counting of the number of electrons that are present on the different electron shells. In one embodiment said bar can also be used to mark the names of the respective electron shells (K, L, M, N . . . ) using printed characters or Braille.

Yet one alternative accessory is a bracket to put the atom on in order to provide an alternative height of the atom.

Yet one alternative accessory is a bracket that houses more than one electron shell. The height of the bracket can be adjusted to suit both the height of said container when the electron shells on its bottom side are used and the suit the height of the lid when the electron shells on the top side of the lid are used. The bracket that houses the additional electron shells can be placed such that the additional electron shells are positioned outside the existing electron shells of the container or lid. This makes the atomic model useful also for more complicated studies of atoms having higher atomic numbers.

In an alternative embodiment, where said bracket with additional electron shells is placed outside the ordinary electron shells, the atomic model can be used for different purposes, i.e. for illustrating the composition of the solar system. A set of “planets” can be bought as an accessory in this alternative embodiment. Said “planets” can be positioned on the electron shells that in such instance represent planet orbits circling the sun. The sun can be represented by the atomic nucleus, or alternatively a solar symbol is placed in said nucleus.

In alternative embodiments the atomic model can also be used by means of a computer. One alternative is an interactive computer program that allows the user to build atoms and ions. It is also possible to provide educational material on a computer that the tutor can use to illustrate the composition of atoms and ions for users. Said educational material can be shown to a group, i.e. by means of the computer program PowerPoint®, where atoms or ions can be formed piece by piece. Thereby the tutor is able to show how the atomic model is used or to illustrate the composition of atoms or ions without the practical function of the atomic model.

The atomic model can for example be made in plastic material. Alternative materials include metal, providing the possibility of making said shell or elementary particles magnetic, rubber, wood, or paper. It is possible to vary the characteristics of the plastic material by using different plastics (e.g. ABS plastic, PVC plastic).

Forming the atomic model with magnetic effect in said electron shells or said elementary particles provides the advantage that the elementary particles do not easily slip off the electron shells. Forming the atomic model in rubber provides the advantage that the model becomes more durable, slightly flexible in its shape, and also that the rubber provides an anti-slip effect that stops the elementary particles from sliding on the electron shells which can be an advantage for certain embodiments. Forming the model out of paper or wood is an environmentally friendly alternative. The paper model can be sold unassembled thereby providing a low-cost alternative having shorter life-time than the other alternatives mentioned above and suitable for use as advertising material.

Yet one alternative is to form the various atomic model parts in different materials. Said container and lid can for example be formed in a plastic material in order to provide rigidness, said electron shells on the lid and on the bottom face of the container can be formed in metal, and said elementary particles can be formed in rubber in order to provide a flexible fit with the electron shells. Said atomic model can be designed in a number of different colours. All the respective parts of the atomic model can be of uniform colour, or alternatively the respective parts can each be coloured in distinctly different colours.

According to one embodiment the elementary particles are coloured differently. The elevations on said elementary particles are also coloured in a distinct colour compared to the rest of the elementary particles. Said elementary particles can be formed in different colours, and also the elevations can be coloured differently. According to the illustrated embodiment the neutrons are two-coloured. In alternative embodiments the neutrons can be uniformly coloured or provided with a different symbol on its upper side, either printed on the material or as a relief. Other alternative embodiments include for example that said electron shells are uniformly coloured in contrast to a differently coloured lid. The respective shells can also be differently coloured. The part of the lid that is visible between said shells can also be given different colours. Said depressed circular space can also be coloured differently than the rest of the lid, as is illustrated in FIG. 2. In an alternative embodiment said circular space can be coloured in the same colour as the rest of the lid, or coloured in multiple colours. In an alternative embodiment said container that houses a set of electron shells on its bottom side is also coloured in different colours. According to FIG. 1 and FIG. 2 the electron shells are formed in a colour that strongly contrast said uniformly coloured container, but the can alternatively be coloured I different colours in order to achieve different visual effects. The interactive atomic model can be used by anyone. The largest target group is pupils, primarily in the senior level of the nine-year school or in senior high school, to be used within natural sciences. The interactive atomic model provides the possibility to a larger number of pupils to understand the constitution of atoms and ions since it employs a larger number of senses. The atomic model is designed to be used also by disabled persons since it does not require any higher level of skilled movements such as writing nor does it require any visual capabilities to register visual information.

The atomic model can be used also outside school. In an alternative embodiment it can be used as a game, manually or electronically, in experimental laboratories as experience-based material or as an interactive computer game. These embodiments can suit both older and younger users. The purpose of these alternatives is to educate under simple and inviting forms.

The interactive atomic model might be called “BRIGHT box”.

1. An interactive atomic model comprising a compartment that is contained by walls and a lid that can be opened, and at least two elementary particle models which are contained in said compartment, whereby said lid has a first atomic model surface that defines a centre area and a number of closed orbits encircling said centre area, whereby said centre area defines resting positions that are well defined in space for at least one of said elementary particle models and said closed orbits define well defined resting positions along the respective closed orbit for at least one of said elementary particle models.

2. An interactive atomic model in accordance with claim 1, wherein said elementary particle models correspond to protons, electrons, and neutrons.

3. An interactive atomic model in accordance with claim 2, wherein the elementary particle models corresponding to protons, electrons, and neutrons are distinguishable by means of physical sensing.

4. An interactive atomic model in accordance with claim 3, wherein elementary particle models corresponding to protons, electrons, and neutrons are visually distinguishable.

5. An interactive atomic model according to claim 1, wherein said centre area and closed orbits are delimited by elevations and depressions in said first atomic model surface.

6. An interactive atomic model according to claim 1, wherein said first atomic model surface and elementary particle models are formed such that a magnetic force retains said elementary particle models against said first atomic model surface in said centre area and closed orbits.

7. An interactive atomic model in accordance with claim 1, further comprising a second atomic model surface that define a second centre area and a second set of closed orbits encircling said second centre area, wherein elementary particle models are transferable between resting positions at the first atomic model surface and corresponding resting positions on the second atomic model surface.
